(19) United States
(12) Patent Application Publication
(10) Pub. No.: US 2024/0346371 A1
(43) Pub. Date: Oct. 17, 2024

(54) MODEL CUSTOMIZATION FOR DOMAIN-SPECIFIC TASKS

(71) Applicant: ROKU, INC., San Jose, CA (US)

(72) Inventors: Abhishek MAJUMDAR, Santa Clara, CA (US); Kapil KUMAR, London (GB); Ravi TIWARI, San Francisco, CA (US); Nitish AGGARWAL, Sunnyvale, CA (US); Srimaruti Manoj NIMMAGADDA, Saratoga, CA (US); Yuannan CAI, San Francisco, CA (US)

(73) Assignee: ROKU, INC., San Jose, CA (US)

(21) Appl. No.: 18/391,979

(22) Filed: Dec. 21, 2023

Related U.S. Application Data
(60) Provisional application No. 63/459,530, filed on Apr. 14, 2023.

(51) Int. Cl. G06N 20/00

(52) U.S. Cl. CPC G06N 20/00

(57) ABSTRACT

Disclosed herein are system, apparatus, article of manufacture, method and/or computer program product embodiments, and/or combinations and sub-combinations thereof, for model customization for domain-specific tasks. An embodiment may select a pre-trained embedding model trained with a first dataset. The embodiment may determine a second dataset for a target domain. Based on target embeddings for data indicative of the target domain. The embodiment may transform the second dataset from a first format to a second format associated with the target domain. The embodiment may modify the weights of the pre-trained embedding model based on the transformed second dataset. Based on the modified weights, the embodiment may transform the pre-trained embedding model into a target embedding model for the target domain. The embodiment may then generate an efficacy score for the target embedding model based on a task of the target domain performed by the target embedding model.

### CROSS-REFERENCE TO RELATED APPLICATIONS

This application claims the benefit of U.S. Provisional Patent Application No. 63/459,530, filed Apr. 14, 2023, the contents of which are incorporated herein by reference in its entirety.

### BACKGROUND

### Field

This disclosure is generally directed to machine learning applications, and more particularly to model customization for domain-specific tasks.

### Background

Despite a large collection of pre-trained language models, using them directly in a target domain is routinely ineffective. Since pre-trained models are trained on a large and diverse dataset, they generalize to broad topics but fail to be specific to a target domain. When applying pre-trained models to a content retrieval domain, the pre-trained models may attempt to utilize exact match similarity measures or other statistical methods to identify content or content items relevant to a query. However, exact match similarity measures and other statistical methods underperform when queries for content items are ambiguous. For example, exact match similarity measures and other statistical methods underperform when users attempt to browse content in a content item catalog or searchable system by giving partial and/or incorrect query information.

### SUMMARY

Provided herein are system, apparatus, article of manufacture, method and/or computer program product embodiments, and/or combinations and sub-combinations thereof, for model customization for domain-specific tasks. A content retrieval system may select a pre-trained embedding model with weights based on training with a first dataset. A second dataset for a target domain may be determined. Based on target embeddings for data indicative of the target domain, the second dataset may be transformed from a first format to a second format associated with the target domain. The weights of the pre-trained embedding model may be modified based on the transformed second dataset. Based on the modified weights of the pre-trained embedding model, the pre-trained embedding model may be transformed into a target embedding model for the target domain. An efficacy score for the target embedding model may be generated based on a task of the target domain performed by the target embedding model.

### BRIEF DESCRIPTION OF THE FIGURES

The accompanying drawings are incorporated herein and form a part of the specification.

FIG. 1 illustrates a block diagram of a multimedia environment, according to some aspects of this disclosure.

FIG. 2 illustrates a block diagram of a streaming media device, according to some aspects of this disclosure.

FIG. 3 illustrates an example system for training a model for domain-specific tasks, according to some embodiments.

FIG. 4 illustrates a flowchart of an example training method for generating a machine learning classifier to classify data used for domain-specific tasks, according to some embodiments.

FIG. 5 illustrates a flowchart of an example method for model customization for domain-specific tasks, according to some embodiments.

FIG. 6 illustrates a flowchart of an example method for model customization for domain-specific tasks, according to some embodiments.

FIG. 7 illustrates an example computer system useful for implementing various embodiments.

In the drawings, like reference numbers generally indicate identical or similar elements. Additionally, generally, the left-most digit(s) of a reference number identifies the drawing in which the reference number first appears.

### DETAILED DESCRIPTION

Provided herein are system, apparatus, device, method and/or computer program product embodiments, and/or combinations and sub-combinations thereof, for model customization for domain-specific tasks. As used in the specification and the appended claims, “content items” may also be referred to as “content,” “content data,” “content information,” “content asset,” “multimedia asset data file,” or simply “data” or “information”. Content items may be any information or data that may be licensed to one or more individuals (or other entities, such as businesses or groups). Content may be electronic representations of video, audio, text, graphics, or the like which may be but is not limited to electronic representations of videos, movies, or other multimedia, which may be but is not limited to data files adhering to MPEG2, MPEG, MPEG4 UHD, HDR, 4k, Adobe® Flash® Video (.FLV) format or some other video file format whether the format is presently known or developed in the future. The content items described herein may be electronic representations of music, spoken words, or other audio, which may be but is not limited to data files adhering to the MPEG1 Audio Layer 3 (.MP3) format, Adobe®, CableLabs 1.0,1.1, 3.0, AVC, HEVC, H.264, Nielsen watermarks, V-chip data and Secondary Audio Programs (SAP), Sound Document (.ASND) format, or some other format configured to store electronic audio whether the format is presently known or developed in the future. In some cases, content may be data files adhering to the following formats: Portable Document Format (.PDF), Electronic Publication (.EPUB) format created by the International Digital Publishing Forum (IDPF), JPEG (.JPG) format, Portable Network Graphics (.PNG) format, dynamic ad insertion data (.csv), Adobe® Photoshop® (.PSD) format or some other format for electronically storing text, graphics and/or other information whether the format is presently known or developed in the future. Content items may be any combination of the above-described formats.

According to some aspects of this disclosure, a content retrieval system, which may be implemented on one or more computing devices, includes a model (e.g., a predictive model, machine learning model, artificial intelligence model, deep learning model, etc.) that has been retrained and/or customized for domain-specific tasks. For example, the model may be an out-of-box and/or generic model that is retrained and/or customized for domain-specific tasks. According to some aspects of this disclosure, training data may be generated to train a model for domain-specific tasks including, but not limited to, content item retrieval of the most relevant items for a query based on user behavior (e.g., user-influenced query-item mapping, etc.) and queried content item data (e.g., title character feature-based query mapping, etc.). According to some aspects of this disclosure, the retrained and/or customized model may be implemented within a target domain to perform domain-specific tasks. For example, according to some aspects of this disclosure, a generic predictive model may be retrained to intelligently manage unstructured content-related data to indicate the most relevant content items responsive to a query. These and other technological advantages are described herein.

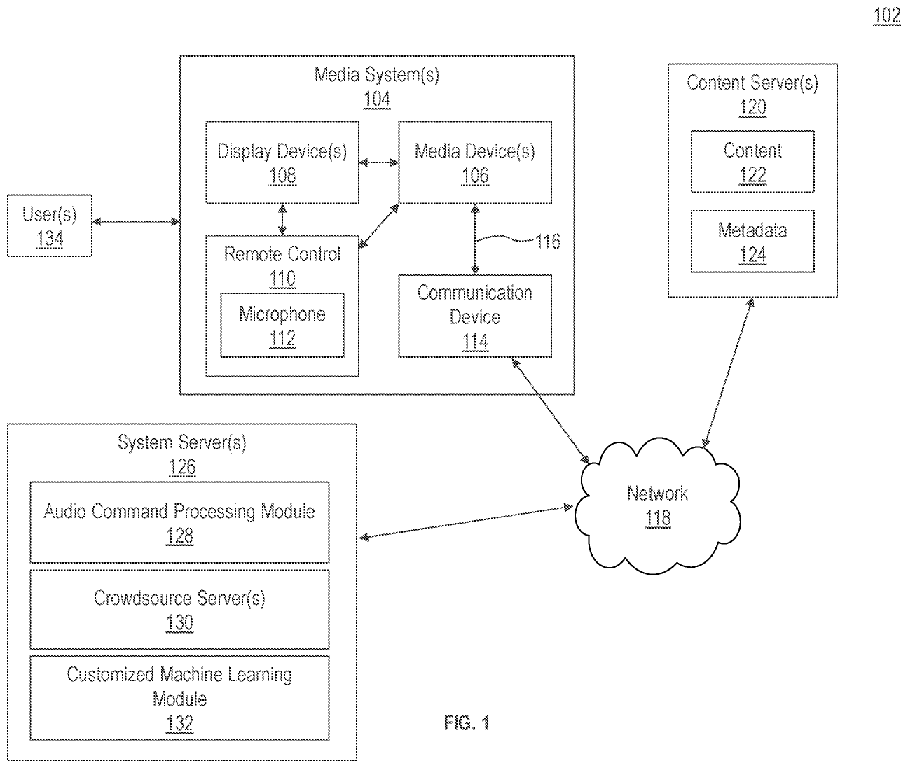

Various embodiments of this disclosure may be implemented using and/or may be part of a multimedia environment 102 shown in FIG. 1. It is noted, however, that multimedia environment 102 is provided solely for illustrative purposes, and is not limiting. Embodiments of this disclosure may be implemented using and/or may be part of environments different from and/or in addition to the multimedia environment 102, as will be appreciated by persons skilled in the relevant art(s) based on the teachings contained herein. An example of the multimedia environment 102 shall now be described.

### Multimedia Environment

FIG. 1 illustrates a block diagram of a multimedia environment 102, according to some embodiments. In a non-limiting example, multimedia environment 102 may be directed to streaming media. However, this disclosure is applicable to any type of media (instead of or in addition to streaming media), as well as any mechanism, means, protocol, method, and/or process for distributing media.

According to some aspects of this disclosure, multimedia environment 102 may include one or more media systems 104. According to some aspects of this disclosure, media system 104 could represent a family room, a kitchen, a backyard, a home theater, a school classroom, a library, a car, a boat, a bus, a plane, a movie theater, a stadium, an auditorium, a park, a bar, a restaurant, or any other location or space where it is desired to receive and play streaming content. According to some aspects of this disclosure, user(s) 134 may interact with the media system 104 to query, select, and/or consume content items.

According to some aspects of this disclosure, each media system 104 may include one or more media devices 106 each coupled to one or more display devices 108. It is noted that terms such as “coupled,” “connected to,” “attached,” “linked,” “combined” and similar terms may refer to physical, electrical, magnetic, logical, etc., connections, unless otherwise specified herein.

According to some aspects of this disclosure, the media device 106 may be a streaming media device, DVD or BLU-RAY device, audio/video playback device, cable box, and/or digital video recording device, to name just a few examples. Display device 108 may be a monitor, television (TV), computer, mobile device, smart device, tablet, wearable (such as a watch or glasses), appliance, internet of things (IoT) device, and/or projector, to name just a few examples. According to some aspects of this disclosure, media device 106 can be a part of, integrated with, operatively coupled to, and/or connected to its respective display device 108.

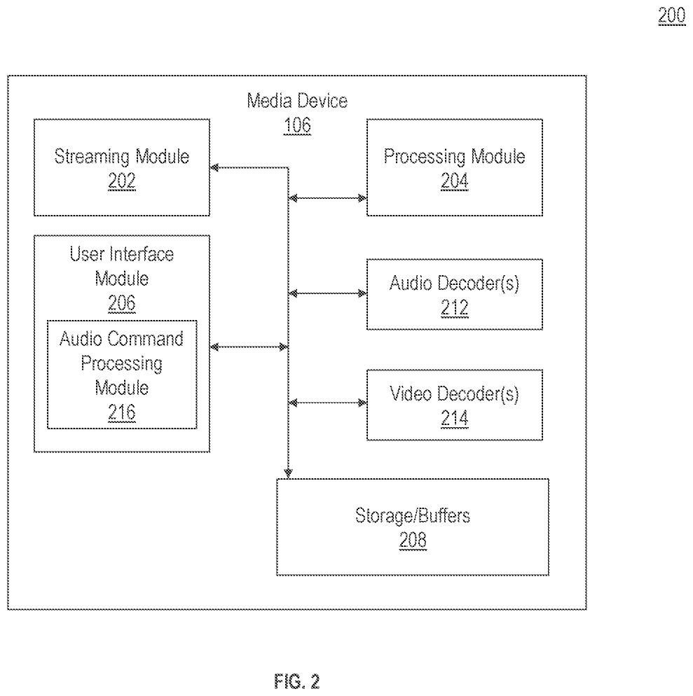

FIG. 2 illustrates a block diagram 200 of an example media device 106, according to some embodiments. Media device 106 may include a streaming module 202, processing module 204, storage/buffers 208, and user interface module 206. The user interface module 206 may include an audio command processing module 216.

According to some aspects of this disclosure, the media device 106 may include one or more audio decoders 212 and one or more video decoders 214. Each audio decoder 212 may be configured to decode audio of one or more audio formats, such as but not limited to AAC, HE-AAC, AC3 (Dolby Digital), EAC3 (Dolby Digital Plus), WMA, WAV, PCM, MP3, OGG GSM, FLAC, AU, AIFF, and/or VOX, to name just some examples. Similarly, each video decoder 214 may be configured to decode video of one or more video formats, such as but not limited to MP4 (mp4, m4a, m4v, f4v, f4a, m4b, m4r, f4b, mov), 3GP (3gp, 3gp2, 3g2, 3gpp, 3gpp2), OGG (ogg, oga, ogv, ogx), WMV (wmv, wma, asf), WEBM, FLV, AVI, QuickTime, HDV, MXF (OP1a, OP-Atom), MPEG-TS, MPEG-2 PS, MPEG-2 TS, WAV, Broadcast WAV, LXF, GXF, and/or VOB, to name just some examples. Each video decoder 214 may include one or more video codecs, such as but not limited to H.263, H.264, H.265, AVI, HEV, MPEG1, MPEG2, MPEG-TS, MPEG-4, Theora, 3GP, DV, DVCPRO, DVCPRO, DVCProHD, IMX, XDCAM HD, XDCAM HD422, and/or XDCAM EX, to name just some examples.

Returning to FIG. 1, each media device 106 may be configured to communicate with network 118 via a communication device 114. The communication device 114 may include, for example, a cable modem or satellite TV transceiver. The media device 106 may communicate with the communication device 114 over a link 116, wherein the link 116 may include wireless (such as Wi-Fi) and/or wired connections.

According to some aspects of this disclosure, network 118 can include, without limitation, wired and/or wireless intranet, extranet, Internet, cellular, Bluetooth, infrared, and/or any other short-range, long-range, local, regional, global communications mechanism, means, approach, protocol and/or network, as well as any combination(s) thereof.

According to some aspects of this disclosure, media system 104 may include a remote control 110. The remote control 110 can be any component, part, apparatus, and/or method for controlling the media device 106 and/or display device 108, such as a remote control, a tablet, laptop computer, smartphone, wearable, on-screen controls, integrated control buttons, audio controls, or any combination thereof, to name just a few examples. In an embodiment, the remote control 110 wirelessly communicates with the media device 106 and/or display device 108 using cellular, Bluetooth, infrared, etc., or any combination thereof. The remote control 110 may include a microphone 112, which is further described below.

According to some aspects of this disclosure, multimedia environment 102 may include a plurality of content servers 120 (also called content providers, channels, or content server(s) 120). Although only one content server 120 is shown in FIG. 1, in practice the multimedia environment 102 may include any number of content servers 120. Each content server 120 may be configured to communicate with network 118.

According to some aspects of this disclosure, each content server 120 may store content 122 and metadata 124. According to some aspects of this disclosure, content 122 may include advertisements, promotional content, commercials, and/or any advertisement-related content. According to some aspects of this disclosure, content 122 may include any combination of advertising supporting content including, but not limited to, content items (e.g. movies, episodic serials, documentaries, content, etc.), music, videos, movies, TV programs, multimedia, images, still pictures, text, graphics, gaming applications, ad campaigns, programming content, public service content, government content, local community content, software, and/or any other content and/or data objects in electronic form.

According to some aspects of this disclosure, metadata 124 comprises data about content 122. For example, metadata 124 may include associated or ancillary information indicating or related to writer, director, producer, composer, artist, actor, summary, chapters, production, history, year, trailers, alternate versions, related content, applications, objects depicted in content items, object types, closed captioning data/information, audio description data/information, and/or any other information pertaining or relating to the content 122. Metadata 124 may also or alternatively include links to any such information pertaining or relating to the content 122. Metadata 124 may also or alternatively include one or more indexes of content 122, such as but not limited to a trick mode index.

According to some aspects of this disclosure, multimedia environment 102 may include one or more system server(s) 126. The system server(s) 126 may operate to support the media devices 106 from the cloud. It is noted that the structural and functional aspects of the system server(s) 126 may wholly or partially exist in the same or different ones of the system server(s) 126.

According to some aspects of this disclosure, system server(s) 126 may include an audio command processing module 128. As noted above, the remote control 110 may include a microphone 112. The microphone 112 may receive audio data from users 134 (as well as other sources, such as the display device 108). According to some aspects of this disclosure, the media device 106 may be audio responsive, and the audio data may represent verbal commands from the user 134 to control the media device 106 as well as other components in the media system 104, such as the display device 108.

According to some aspects of this disclosure, the audio data received by the microphone 112 in the remote control 110 is transferred to the media device 106, which is then forwarded to the audio command processing module 128 in the system server(s) 126. The audio command processing module 128 may operate to process and analyze the received audio data to recognize the user 134's verbal command. The audio command processing module 128 may then forward the verbal command back to the media device 106 for processing.

According to some aspects of this disclosure, the audio data may be alternatively or additionally processed and analyzed by an audio command processing module 216 in the media device 106 (see FIG. 2). The media device 106 and the system server(s) 126 may then cooperate to pick one of the verbal commands to process (either the verbal command recognized by the audio command processing module 128 in the system server(s) 126, or the verbal command recognized by the audio command processing module 216 in the media device 106).

Now referring to both FIGS. 1 and 2, in some embodiments, user 134 may interact with the media device 106 via, for example, the remote control 110. For example, user 134 may use the remote control 110 to interact with the user interface module 206 of the media device 106 to query/search and/or select content, such as a movie, TV show, music, book, application, game, etc. The streaming module 202 of the media device 106 may request the selected content from the content server(s) 120 over the network 118. The content server(s) 120 may transmit the requested content to the streaming module 202. The media device 106 may transmit the received content to the display device 108 for playback to the user 134.

According to some aspects of this disclosure, the media system 104 may include devices and/or components supporting and/or facilitating linear television, inter-device/component communications (e.g., HDMI inputs connected to gaming devices, etc.), online communications (e.g., Internet browsing, etc.) and/or the like.

According to some aspects of this disclosure, for example, in streaming embodiments, the streaming module 202 may transmit the content to the display device 108 in real-time or near real-time as it receives such content from the content server(s) 120. In non-streaming embodiments, the media device 106 may store the content received from content server(s) 120 in storage/buffers 208 for later playback on display device 108.

According to some aspects of this disclosure, the media devices 106 may exist in thousands or millions of media systems 104. Accordingly, the media devices 106 may lend themselves to crowdsourcing embodiments and, thus, the system server(s) 126 may include one or more crowdsource server(s) 130.

According to some aspects of this disclosure, using information received from the media devices 106 in the thousands and millions of media systems 104, the crowdsource server(s) 130 may identify similarities and overlaps between closed captioning requests issued by different users 134 watching a content item, advertisement, and/or the like. Based on such information, the crowdsource server(s) 130 may determine that turning closed captioning on may enhance users' viewing experience at particular portions of the content item, advertisement, and/or the like (for example, when the soundtrack of the content item, advertisement, and/or the like is difficult to hear), and turning closed captioning off may enhance users' viewing experience at other portions of the content item, advertisement, and/or the like (for example, when displaying closed captioning obstructs critical visual aspects of the content item, advertisement, and/or the like). Accordingly, the crowdsource server(s) 130 may operate to cause closed captioning to be automatically turned on and/or off during future streaming of the content item, advertisement, and/or the like.

According to some aspects of this disclosure, using information received from the media devices 106 (and/or user device(s) 103) in the thousands and millions of media systems 104, the crowdsource server(s) 130 may identify media devices (and/or user devices) to target with and/or acquire from bid stream data, communications, information, and/or the like. For example, the most popular content items may be determined based on the amount of content items are requested (e.g., viewed, accessed, etc.) by media devices 106.

According to some aspects of this disclosure, using information received from the media devices 106 in the thousands and millions of media systems 104, the crowdsource server(s) 130 may identify similarities and overlaps between closed captioning requests issued by different users 134 watching a particular movie. Based on such information, the crowdsource server(s) 130 may determine that turning closed captioning on may enhance users' viewing experience at particular portions of the movie (for example, when the soundtrack of the movie is difficult to hear), and turning closed captioning off may enhance users' viewing experience at other portions of the movie (for example, when displaying closed captioning obstructs critical visual aspects of the movie). Accordingly, the crowdsource server(s) 130 may operate to cause closed captioning to be automatically turned on and/or off during future streaming of the movie.

According to some aspects of this disclosure, the system server(s) 126 may include a customized machine learning module 132. According to some aspects of this disclosure, classifiers, for example, content-related classifiers, content item-related classifiers, semantic classifiers, textual data classifiers, image data classifiers, audio data classifiers, ancillary data classifiers, and/or the like, used by the customized machine learning module 132 may be explicitly trained based on labeled datasets relating to a target domain. According to some aspects of this disclosure, customized machine learning module 132 may be trained on data derived from user-influenced query-item mapping, title character feature-based query mapping to improve categorical search and/or query results and user engagement (e.g., click-through rates, launch rates, streaming hours, etc.) with the categorical search and/or query results. According to some aspects of this disclosure, classifiers, for example, such as content-related classifiers, content item-related classifiers, semantic classifiers, textual data classifiers, image data classifiers, audio data classifiers, ancillary data classifiers, and/or the like, used by the customized machine learning module 132 may be implicitly trained (e.g., via results from content retrieval, identification, and/or recommendation task, etc.). For example, the customized machine learning module 132 may include support vector machines configured via a learning or training phase within a classifier constructor and feature selection module.

According to some aspects of this disclosure, classifier(s) may be used by the customized machine learning module 132 to automatically learn and perform functions, including but not limited to model customization for domain-specific tasks and/or the like.

According to some aspects of this disclosure, the trained customized machine learning module 132 may use processing techniques, such as artificial intelligence, semantic analysis, lexical analysis, exact-match retrieval, statistical models, logical processing algorithms, and/or the like to indicate the most relevant content items responsive to a query.

According to some aspects of this disclosure, the customized machine learning module 132 may use classifiers that map an attribute vector to a confidence that the attribute belongs to a class. For example, the customized machine learning module 132 may use classifiers that map vectors that represent attributes of content items either queried/searched for or resident within an entity-owned and/or managed repository. For example, an attribute vector, x= (x1, x2, x3, x4, xn) may be mapped to f(x)=confidence (class).

According to some aspects of this disclosure, domain-specific activities performed by the customized machine learning module 132 may employ a probabilistic and/or statistical-based analysis. According to some aspects of this disclosure, domain-specific activities performed by the customized machine learning module 132 may use any type of directed and/or undirected model classification approaches including, but not limited to, naïve Bayes, Bayesian networks, decision trees, neural networks, fuzzy logic models, and probabilistic classification models providing different patterns of independence. Classification may also include statistical regression that is utilized to develop models of priority.

### Model Customization for Domain-Specific Tasks

According to some aspects of this disclosure, system server(s) 126 (e.g. customized machine learning module 132, etc.) operate to facilitate model customization for domain-specific tasks. According to some aspects of this disclosure, system server(s) 126 may train a predictive model that can map partial queries to content items available within a repository, catalog, database, available via a service, and/or the like. By entering text into a search tool (e.g., typing characters into a user interface element, etc.) users engage with multimedia environment 102 and can access, display, and/or consume a desired content item. For example, a user (e.g., user 14, etc.) intent to watch the movie “Harry Potter and the Order of the Phoenix,” may type “h,” “ha,” “har,” . . . . Alternatively the user could start by typing “o,” “or,” “ord,” . . . . As another example, a user (e.g., user 134, etc.) intent to watch the movie “No Time to Die”, the user could come into the platform and type “n,” “no,” “no,” “no t” . . . . Alternatively the user could start by typing “0” “00” “007” . . . . Therefore, system server(s) 126 (e.g. customized machine learning module 132, etc.) may train a generic language model to forecast information and/or make predictions for the target domain, such as providing the most relevant content items as a result to partial query/character information.

According to some aspects of this disclosure, training or retraining a generic language model (e.g., a pre-trained embedding model, etc.) for domain-specific tasks may be based on custom training data for the target domain. For example, for a content retrieval domain, custom training data may reflect how users prefer to query tent items and may map content items to word/character features of their respective titles.

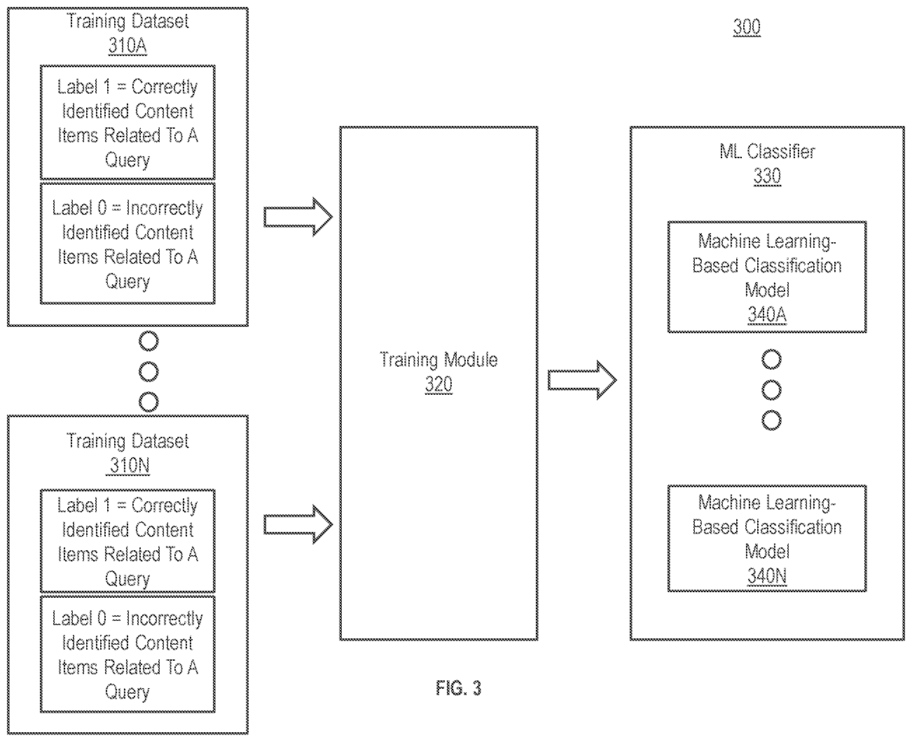

FIG. 3 is an example system 300 for training generic language models (e.g., pre-trained embedding models, etc.) of the customized machine learning module 132 to perform domain-specific tasks for a target domain. FIG. 3 is described with reference to FIG. 1.

According to some aspects of this disclosure, system 300 may use machine learning techniques to train one or more pre-trained machine learning-based classifiers 330 (e.g., a software model, neural network classification layer, etc.) for domain-specific classification tasks. The machine learning-based classifier 330 may be a pre-trained classifier that is retrained by the customized machine learning module 132 based on one or more training datasets 310A-310N.

According to some aspects of this disclosure, training datasets may be generated based on user-influenced query-item mapping. For example, according to some aspects of this disclosure, one or more training datasets 310A-310N may comprise labeled data such as labels that indicate features extracted from user queries associated with certain items. The features may be used to train machine learning-based classifiers 330 to map partial queries to the closest and/or most relevant items based on historical user (e.g., user 134, etc.) actions (e.g., frequently accessed content items, etc.) within multimedia environment 102. For example, one or more crowdsource server(s) 130 may provide customized machine learning module 132 with logs of user activity for a timeframe (e.g., a week, a month, a year, etc.).

According to some aspects of this disclosure, TABLE 1 below shows an example table of log data (e.g., generated from data from one or more crowdsource server(s) 130, etc.) captured over a timeframe (e.g., thirty days, etc.) that indicates various user profiles, the data submitted by the respective users for the user profiles during queries (e.g., queries submitted via media device(s) 106, etc.) for content items and the corresponding content items that launched (e.g., accessed, displayed, consumed, etc.) by the media devices of the respective users for the user profiles during various sessions.

TABLE 1

| User Profile | Query Data | Launched Content Item |
|---|---|---|
| User ID 1 | 007 | Item 1 |
| User ID 2 | 00 | Item 1 |
| User ID 3 | 007 | Item 1 |
| User ID 4 | zz0 | Item 2 |
| User ID 5 | zz0 | Item 2 |
| User ID 6 | zz09 | Item 2 |
| User ID 7 | na | Item 3 |
| User ID 8 | nemo | Item 4 |

According to some aspects of this disclosure, logged queries may be exploded to sub-queries for corresponding launched content items for the different sessions. For example, if a content item was launched based on query data “007”, queries using query data “007” may be exploded to partial queries and/or sub-queries as “0”, “00”, “007” and the launch of the Item 1 may be attributed to each of the partial queries and/or sub-queries. Additionally, if a content item was launched based on query data “nemo”, queries using query data “nemo” may be exploded to partial queries and/or sub-queries as “n”, “ne”, “nem” and the launch of the Item 4 may be attributed to each of the partial queries and/or sub-queries. For each content item (e.g., Items 1-4), a launch frequency and the log (frequency)+1 rounded to the closest integer for a given query may be computed. TABLE 2 below shows an example table of query data, launch frequency data, and the log (frequency)+1 rounded to the closest integer for a given query.

TABLE 2

| Launched Content Item | Query Data | Frequency | Log(frequency) + 1 |
|---|---|---|---|
| Item 1 | 0 | 27 | 4 |
| Item 1 | 00 | 27 | 4 |
| Item 1 | 007 | 27 | 4 |
| Item 4 | n | 200 | 6 |
| Item 4 | ne | 200 | 6 |
| Item 4 | nem | 100 | 6 |

According to some aspects of this disclosure, a labeled baseline dataset may include item-based documents containing the partial queries and/or sub-queries replicated log frequency values (e.g., Log (frequency)+1). For example, as shown in TABLE 2 for Item 1, the queries “0”, “00”, “007” had log frequency values equal to four. According to some aspects of this disclosure, the labeled baseline dataset may include a query-item mapping such that items are mapped to query data. For example, as shown in example TABLE 3, Item 1 may be mapped to “0”, “00”, “007”, “0”, “00”, “007”, “0”, “00”, “007”, “0”, “00”, “007” . . . nth. For example, each partial query and/or sub-query contributing to the launch of Item 1 may be repeated for an amount of times corresponding to the log frequency values in the item-based dataset for the item.

TABLE 3

| Launched Content Item | Document |
|---|---|
| Item 1 | 0, 00, 007, 0, 00, 007, . . . |
| Item 4 | n, ne, nem, n, ne, nem, . . . |

According to some aspects of this disclosure, training datasets may be generated based on title character feature-based query mapping. For title character feature-based query mapping, character-based features of the titles may be used to improve the relevance and accuracy of query mappings. For example, according to some aspects of this disclosure, one or more training datasets 310A-310N may comprise labeled data such as labels that indicate the features from the title of a corresponding content item based on natural language processing and/or the like. Character Features may be extracted from the characters in a plurality of content item titles based on techniques including, but not limited to, generation of n-grams (sequences of n characters), generation of edge-n grams, calculating character frequency distributions, string cleaning, text flattening, character co-occurrence patterns, and/or the like. For example, for each content item available within an entity repository, catalog, database, via a service, and/or the like, character and word-level features may be extracted. For example, for a content item titled “The Dream Factory,” unigrams (e.g., the, dream, factory), bigrams (e.g., the dream, dream factory), edge bigrams for every word (e.g., th, dr, fa), and/or edge trigrams for every word (e.g., the, dre, fac) may be determined. Additionally, corrupted word features for explicit spell correction may also be generated.

According to some aspects of this disclosure, similarly to the description for user-influenced query-item mapping, as shown in example TABLE 4, for title character feature-based query mapping, a frequency distribution of content item launches in overall logs at a global level may be generated.

TABLE 4

| Titled Content Item | Frequency | Log(frequency ) + 1 |
|---|---|---|
| Item 1 | 27 | 4 |
| Item 4 | 122 | 6 |

According to some aspects of this disclosure, the labeled baseline dataset may include an title character feature-based query mapping such that content items are mapped to title character data. Example TABLE 5 shows extracted word features from the document log frequency value.

TABLE 5

| Titled Content Item | Document |
|---|---|
| Item 1 | quantum, of, solace, quantum of, of solace, qu, of, |
| | so, qua, sol, . . . repeated 4 times |
| Item 4 | finding, nemo, finding nemo, fi, ne, fin, nem, . . . |
| | repeated 6 times |

Character features may be extracted from query terms and compared to the indexed and/or stored character features of content items. According to some aspects of this disclosure, other techniques, such as term frequency-inverse document frequency (TF-IDF) or semantic embeddings like BERT, may also be used to capture richer and more meaningful relationships between queries and content items.

According to some aspects of this disclosure, labeled baseline data may include a union of documents (e.g., TABLE 3, TABLE 5, etc.) generated from user-influenced query-item mapping, title character feature-based query mapping, and/or the like. According to some aspects of this disclosure, labeled baseline data may include any number of feature sets. Feature sets may include, but are not limited to, labeled data that identifies extracted features from requests and/or queries for content items, as well as content items available within a repository, catalog, database, via a service, and/or the like.

According to some aspects of this disclosure, the labeled baseline data may be stored in one or more databases. For example, extracted character features and/or user-behavioral data may be indexed and/or stored to enable efficient search and retrieval. Data for model customization for domain-specific tasks and/or the like may be randomly assigned to a training dataset or a testing dataset.

According to some aspects of this disclosure, the assignment of data to a training dataset or a testing dataset may not be completely random. In this case, one or more criteria may be used during the assignment, such as ensuring that data extracted from and/or associated with user-influenced query-item mappings, title character feature-based query mappings (e.g., similar access frequencies, similar text, similar textual connotations, similar textual semantics, similar lexical items, similar ancillary items, dissimilar access frequencies, dissimilar text, dissimilar textual connotations, dissimilar textual semantics, dissimilar lexical items, dissimilar ancillary items, etc.) may be used in each of the training and testing datasets. In general, any suitable method may be used to assign the data to the training or testing datasets.

According to some aspects of this disclosure, the customized machine learning module 132 may train the machine learning-based classifier 330 by extracting a feature set from the labeled baseline data according to one or more feature selection techniques. According to some aspects of this disclosure, the customized machine learning module 132 may further define the feature set obtained from the labeled baseline data by applying one or more feature selection techniques to the labeled baseline data in the one or more training datasets 310A-310N. The customized machine learning module 132 may extract a feature set from the training datasets 310A-310N in a variety of ways. The customized machine learning module 132 may perform feature extraction multiple times, each time using a different feature-extraction technique. In some instances, the feature sets generated using the different techniques may each be used to generate different machine learning-based classification models 340. According to some aspects of this disclosure, the feature set with the highest quality metrics may be selected for use in training. The customized machine learning module 132 may use the feature set(s) to build one or more machine learning-based classification models 340A-340N for a target domain. For example, the customized machine learning module 132 may use the feature set(s) to build one or more machine learning-based classification models 340A-340N that are configured to determine and/or predict associations between content items and natural language queries/requests for content items.

According to some aspects of this disclosure, the training datasets 310A-310N and/or the labeled baseline data may be analyzed to determine any dependencies, associations, and/or correlations between content items and natural language queries/requests for content items in the training datasets 310A-310N and/or the labeled baseline data. The term “feature,” as used herein, may refer to any characteristic of an item of data that may be used to determine whether the item of data falls within one or more specific categories. According to some aspects of this disclosure, features may include any other information pertaining or relating to content items, as well as queries/requests for content items.

According to some aspects of this disclosure, a feature selection technique may comprise one or more feature selection rules. The one or more feature selection rules may comprise determining which features in the labeled baseline data appear over a threshold number of times in the labeled baseline data and identifying those features that satisfy the threshold as candidate features. For example, any features that appear greater than or equal to 2 times in the labeled baseline data may be considered candidate features. Any features appearing less than 2 times may be excluded from consideration as a feature. According to some aspects of this disclosure, a single feature selection rule may be applied to select features or multiple feature selection rules may be applied to select features. According to some aspects of this disclosure, the feature selection rules may be applied in a cascading fashion, with the feature selection rules being applied in a specific order and applied to the results of the previous rule. For example, the feature selection rule may be applied to the labeled baseline data to generate information (e.g., indications of similarities between content items and items requested/queried, etc.) that may be used for model customization for domain-specific tasks. A final list of candidate features may be analyzed according to additional features.

According to some aspects of this disclosure, the customized machine learning module 132 may generate information (e.g., indications of similarities between content items and items requested/queried, etc.) that may be used for model customization for domain-specific tasks based on a wrapper method. A wrapper method may be configured to use a subset of features and train the machine learning model using the subset of features. Based on the inferences that are drawn from a previous model, features may be added and/or deleted from the subset. Wrapper methods include, for example, forward feature selection, backward feature elimination, recursive feature elimination, combinations thereof, and the like.

According to some aspects of this disclosure, forward feature selection may be used to identify one or more candidate content items that relate to one or more queries for content items. Forward feature selection is an iterative method that begins with no feature in the machine learning model. In each iteration, the feature which best improves the model is added until the addition of a new variable does not improve the performance of the machine learning model. According to some aspects of this disclosure, backward elimination may be used to identify one or more candidate content items that relate to one or more queries for content items. Backward elimination is an iterative method that begins with all features in the machine learning model. In each iteration, the least significant feature is removed until no improvement is observed in the removal of features. According to some aspects of this disclosure, recursive feature elimination may be used to identify one or more candidate content items that relate to one or more queries for content items. Recursive feature elimination is a greedy optimization algorithm that aims to find the best-performing feature subset. Recursive feature elimination repeatedly creates models and keeps aside the best or the worst-performing feature at each iteration. Recursive feature elimination constructs the next model with the features remaining until all the features are exhausted. Recursive feature elimination then ranks the features based on the order of their elimination.

According to some aspects of this disclosure, one or more candidate content items that relate to one or more queries for content items may be determined according to an embedded method. Embedded methods combine the qualities of filter and wrapper methods. Embedded methods include, for example, Least Absolute Shrinkage and Selection Operator (LASSO) and ridge regression which implement penalization functions to reduce overfitting. For example, LASSO regression performs L1 regularization which adds a penalty equivalent to an absolute value of the magnitude of coefficients and ridge regression performs L2 regularization which adds a penalty equivalent to the square of the magnitude of coefficients. According to some aspects of this disclosure, embedded methods may include textual data, image data, audio data, ancillary content item data, and/or the like being mapped to an embedding space to enable similarity between content items within a repository and content items requested and/or search/queried for to be identified.

According to some aspects of this disclosure, after customized machine learning module 132 generates a feature set(s), the customized machine learning module 132 may generate a machine learning-based predictive model 340 based on the feature set(s). A machine learning-based predictive model may refer to a complex mathematical model for data classification that is generated using machine-learning techniques. For example, this machine learning-based classifier may include a map of support vectors that represent boundary features. By way of example, boundary features may be selected from, and/or represent the highest-ranked features in, a feature set.

According to some aspects of this disclosure, the customized machine learning module 132 may use the feature sets extracted from the training datasets 310A-310N and/or the labeled baseline data to build a machine learning-based classification model 340A-340N to determine and/or predict content items that relate to one or more queries for content items and/or the like. According to some aspects of this disclosure, the machine learning-based classification models 340A-340N may be combined into a single machine learning-based classification model 340. Similarly, the machine learning-based classifier 330 may represent a single classifier containing a single or a plurality of machine learning-based classification models 340 and/or multiple classifiers containing a single or a plurality of machine learning-based classification models 340. For example, according to some aspects of this disclosure, machine learning-based classification models 340A-340N may each classify different types of data for a target domain. According to some aspects of this disclosure, the machine learning-based classifier 330 may also include each of the training datasets 310A-310N and/or each feature set extracted from the training datasets 310A-310N and/or extracted from the labeled baseline data. Although shown separately, customized machine learning module 132 may include the machine learning-based classifier 330.

According to some aspects of this disclosure, extracted features from target domain data (e.g., requests and/or queries for content items, as well as content items available within a repository, catalog, database, via a service, etc.) may be combined and/or implemented on classification models trained using a machine learning approach such as a siamese neural network (SNN); discriminant analysis; decision tree; a nearest neighbor (NN) algorithm (e.g., k-NN models, replicator NN models, etc.); statistical algorithm (e.g., Bayesian networks, etc.); clustering algorithm (e.g., k-means, mean-shift, etc.); other neural networks (e.g., reservoir networks, artificial neural networks, etc.); support vector machines (SVMs); logistic regression algorithms; linear regression algorithms; Markov models or chains; principal component analysis (PCA) (e.g., for linear models); multi-layer perceptron (MLP) ANNs (e.g., for non-linear models); replicating reservoir networks (e.g., for non-linear models, typically for time series); random forest classification; a combination thereof and/or the like. The resulting machine learning-based classifier 330 may comprise a decision rule or a mapping that uses data from a target domain to forecast information and/or make predictions for the target domain. For example, resulting machine learning-based classifier 330 may comprise a decision rule or a mapping that uses user-influenced query-item mapping data and/or title character feature-based query mapping data to determine and/or predict content items that relate to one or more queries for content items.

According to some aspects of this disclosure, the data from a target domain (e.g., uses user-influenced query-item mapping data, title character feature-based query mapping data, etc.) and the machine learning-based classifier 330 may be used to forecast information and/or make predictions for a target domain, including, but not limited to, determining and/or predicting content items that relate to one or more queries for content items for the test samples in the test dataset. For example, the result for each test sample may include a confidence level that corresponds to a likelihood or a probability that the corresponding test sample accurately determines and/or predicts content items that relate to one or more queries for content items. The confidence level may be a value between zero and one that represents a likelihood that the determined/predicted content items that relate to one or more queries for content items are consistent with computed values. Multiple confidence levels may be provided for each test sample and each candidate (approximated) content item that relates to one or more queries for content items. A top-performing candidate content item that relates to one or more queries for content items may be determined by comparing the result obtained for each test sample with a computed content item that relates to one or more queries for content items for each test sample. In general, the top-performing candidate content item that relates to one or more queries for content items will have results that closely match the computed content item that relates to one or more queries for content items. The top-performing candidate content items that best match one or more queries for content items may be used for model customization for domain-specific tasks operations.

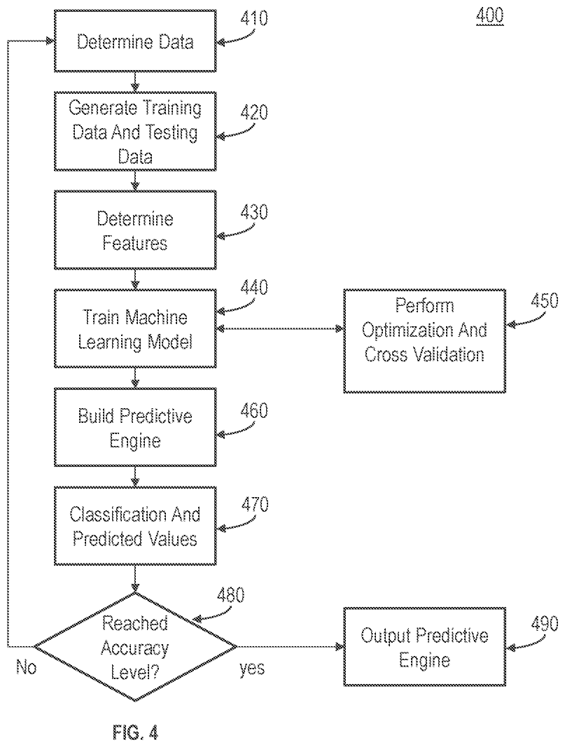

FIG. 4 is a flowchart illustrating an example training method 400, according to some aspects of this disclosure. According to some aspects of this disclosure, method 400 configures machine learning classifier 330 for classification through a training process using the customized machine learning module 132. The customized machine learning module 132 can implement supervised, unsupervised, and/or semi-supervised (e.g., reinforcement-based) machine learning-based classification models 340. The method 400 shown in FIG. 4 is an example of a supervised learning method. Variations of this example of training method are discussed below, however, other training methods can be analogously implemented to train unsupervised and/or semi-supervised machine learning (predictive) models. For example, customized machine learning module 132 can train one or more predictive models to learn meaningful representations of the data (e.g., similarities between content items and requests/queries according to various modalities of data, etc.) without the need for labeled data. For example, according to some aspects of this disclosure, customized machine learning module 132 may implement techniques such as auto-encoders, generative adversarial networks (GANs), or variational autoencoders (VAEs).

According to some aspects of this disclosure, method 400 can be performed by processing logic that can comprise hardware (e.g., circuitry, dedicated logic, programmable logic, microcode, etc.), software (e.g., instructions executing on a processing device), or a combination thereof. It is to be appreciated that not all steps may be needed to perform the disclosure provided herein. Further, some of the steps may be performed simultaneously, or in a different order than shown in FIG. 4, as will be understood by a person of ordinary skill in the art.

Method 400 shall be described with reference to FIGS. 1-3. However, method 400 is not limited to the aspects of those figures.

In 410, the customized machine learning module 132 determines (e.g., accesses, receives, retrieves, etc.) content item-related information. According to some aspects of this disclosure, the content item-related information may be user-influenced query-item mapping data, title character feature-based query mapping data, and/or the like to determine and/or predict content items that relate to one or more queries for content items. According to some aspects of this disclosure, content item-related information may be used to generate one or more datasets, each dataset associated with a different modality of data.

In 420, customized machine learning module 132 generates a training dataset and a testing dataset. According to some aspects of this disclosure, the training dataset and the testing dataset may be generated by indicating content items that relate to one or more queries for content items. According to some aspects of this disclosure, the training dataset and the testing dataset may be generated by randomly assigning a content item that relates to a query to either the training dataset or the testing dataset. According to some aspects of this disclosure, the assignment of information indicative of content items that relate to one or more queries for content items as training or test samples may not be completely random. According to some aspects of this disclosure, only the labeled baseline data for a specific feature extracted from specific content item-related information may be used to generate the training dataset and the testing dataset. According to some aspects of this disclosure, a majority of the labeled baseline data extracted from content item-related information may be used to generate the training dataset. For example, 75% of the labeled baseline data for determining a content item that relates to one or more queries for content items extracted from content item-related information and/or related data may be used to generate the training dataset and 25% may be used to generate the testing dataset. Any method or technique may be used to create the training and testing datasets.

In 430, customized machine learning module 132 determines (e.g., extract, select, etc.) one or more features that can be used by, for example, a classifier (e.g., a software model, a classification layer of a neural network, etc.) to label features extracted from a variety of content item-related information and/or related data. One or more features may comprise indications of content items that relate to one or more queries for content items. According to some aspects of this disclosure, the customized machine learning module 132 may determine a set of training baseline features from the training dataset. Features of content and/or content item data may be determined by any method.

In 440, customized machine learning module 132 trains one or more machine learning models, for example, using the one or more features. According to some aspects of this disclosure, the machine learning models may be trained using supervised learning. According to some aspects of this disclosure, other machine learning techniques may be employed, including unsupervised learning and semi-supervised. The machine learning models trained in 340 may be selected based on different criteria (e.g., how close a predicted content item that relates to one or more queries for content items is to an actual content item that relates to one or more queries for content items, etc.) and/or data available in the training dataset. For example, machine learning classifiers can suffer from different degrees of bias. According to some aspects of this disclosure, more than one machine learning model can be trained.

In 450, customized machine learning module 132 optimizes, improves, and/or cross-validates trained machine learning models. For example, data for training datasets and/or testing datasets may be updated and/or revised to include more labeled data indicating different content items that relate to one or more queries for content items.

In 460, customized machine learning module 132 selects one or more machine learning models to build a predictive model (e.g., a machine learning classifier, a predictive engine, etc.). The predictive model may be evaluated using the testing dataset.

In 470, customized machine learning module 132 executes the predictive model to analyze the testing dataset and generate classification values and/or predicted values.

In 480, customized machine learning module 132 evaluates classification values and/or predicted values output by the predictive model to determine whether such values have achieved the desired accuracy level. Performance of the predictive model may be evaluated in a number of ways based on a number of true positives, false positives, true negatives, and/or false negatives classifications of the plurality of data points indicated by the predictive model. For example, the false positives of the predictive model may refer to the number of times the predictive model incorrectly predicted and/or determined a content item that relates to one or more queries for content items. Conversely, the false negatives of the predictive model may refer to the number of times the machine learning model predicted and/or determined a content item that relates to one or more queries for content items incorrectly, when in fact, the predicted and/or determined a content item that relates to one or more queries for content items matches an actual content item that relates to one or more queries for content items. True negatives and true positives may refer to the number of times the predictive model correctly predicted and/or determined a content item that relates to one or more queries for content items. Related to these measurements are the concepts of recall and precision. Generally, recall refers to a ratio of true positives to a sum of true positives and false negatives, which quantifies the sensitivity of the predictive model. Similarly, precision refers to a ratio of true positives as a sum of true and false positives.

In 490, customized machine learning module 132 outputs the predictive model (and/or an output of the predictive model). For example, customized machine learning module 132 may output the predictive model when such a desired accuracy level is reached. An output of the predictive model may end the training phase.

According to some aspects of this disclosure, when the desired accuracy level is not reached, in 490, customized machine learning module 132 may perform a subsequent iteration of the training method 400 starting at 410 with variations such as, for example, considering a larger collection of content item-related information and/or related data.

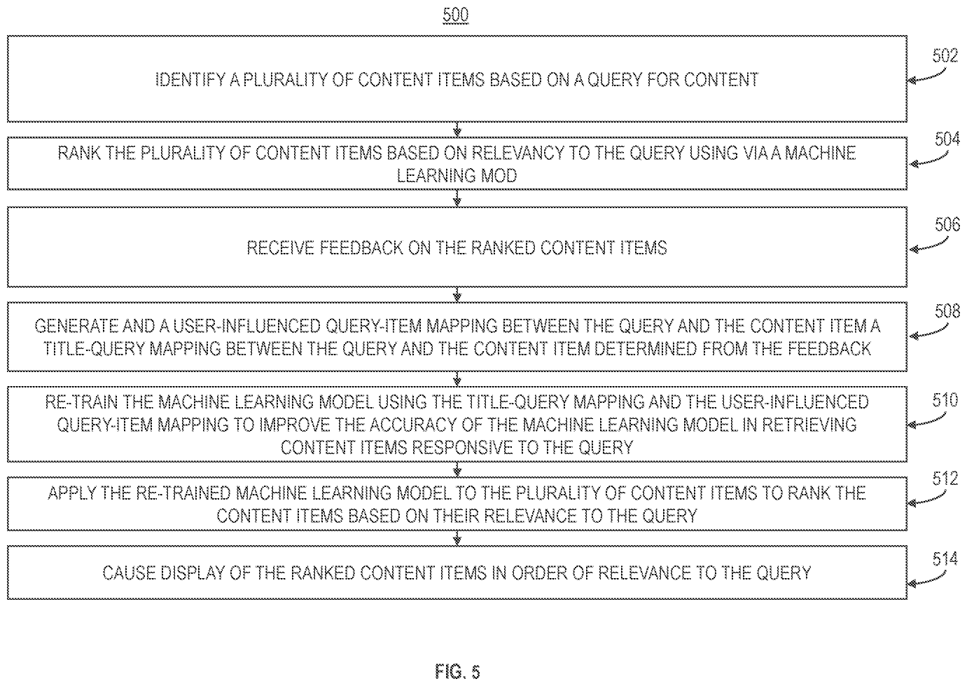

FIG. 5 shows a flowchart of an example method 500 for model customization for domain-specific tasks, according to some aspects of this disclosure. Method 500 can be performed by processing logic that can comprise hardware (e.g., circuitry, dedicated logic, programmable logic, microcode, etc.), software (e.g., instructions executing on a processing device), or a combination thereof. It is to be appreciated that not all steps may be needed to perform the disclosure provided herein. Further, some of the steps may be performed simultaneously, or in a different order than shown in FIG. 5, as will be understood by a person of ordinary skill in the art.

Method 500 shall be described with reference to FIGS. 1-4. However, method 500 is not limited to the aspects of those figures. A computer-based system (e.g., the multimedia environment 102, the system server(s) 126, etc.) may facilitate model customization for domain-specific tasks.

In 502, system server(s) 126 identifies a plurality of content items. For example, system server(s) 126 may identify the plurality of content items based on a query for content.

In 504, system server(s) 126 ranks the plurality of content items. For example, system server(s) 126 may use a first machine learning model to rank the plurality of content items based on relevancy to the query. According to some aspects of this disclosure, the first machine learning model may be a generic model (e.g., a pre-trained language model, a pre-trained embedding model, etc.). According to some aspects of this disclosure, the first machine learning model may be a pre-trained embedding model including, but not limited to, word2vec, GloVe, BERT, and/or the like.

In 504, system server(s) 126 receives feedback on the ranked plurality of content items. For example, feedback may be received from a plurality of user devices. According to some aspects of this disclosure, the feedback may include, but is not limited to, user interaction with the plurality of content items, user dwell time associated with the plurality of content items, user engagement metrics for the plurality of content items, and/or the like.

In 506, system server(s) 126 generates a title-query mapping between the query and the content item, and a user-influenced query-item mapping between the query and the content item. For example, system server(s) 126 may generate the title-query mapping between the query and the content item, and the user-influenced query-item mapping between the query and the content item based on the feedback.

In 608, system server(s) 126 retrains the first machine learning model to be a second machine learning model. For example, system server(s) 126 may retrain the first machine learning model to be the second machine learning model based on the title-query mapping and the user-influenced query-item mapping. Retraining the first machine learning model to be the second machine learning model may improve the accuracy of second machine learning model in retrieving content items responsive to the query respective to the first machine learning model.

In 510, system server(s) 126 applies the second machine learning model to the plurality of content items to rank the content items based on relevance to the query.

In 512, system server(s) 126 causes display of the ranked content items in order of relevance to the query.

According to some aspects of this disclosure, the method 500 may further include system server(s) 126 validating the title-query mapping and the user-influenced query-item mapping based on a validation set of queries and content items.

According to some aspects of this disclosure, the method 500 may further include system server(s) 126 applying natural language processing (NLP) to the query and the content items to extract relevant features for the second machine learning model.

According to some aspects of this disclosure, the method 500 may further include system server(s) 126 applying deep learning to the query and the content items to improve the accuracy of the second machine learning model.

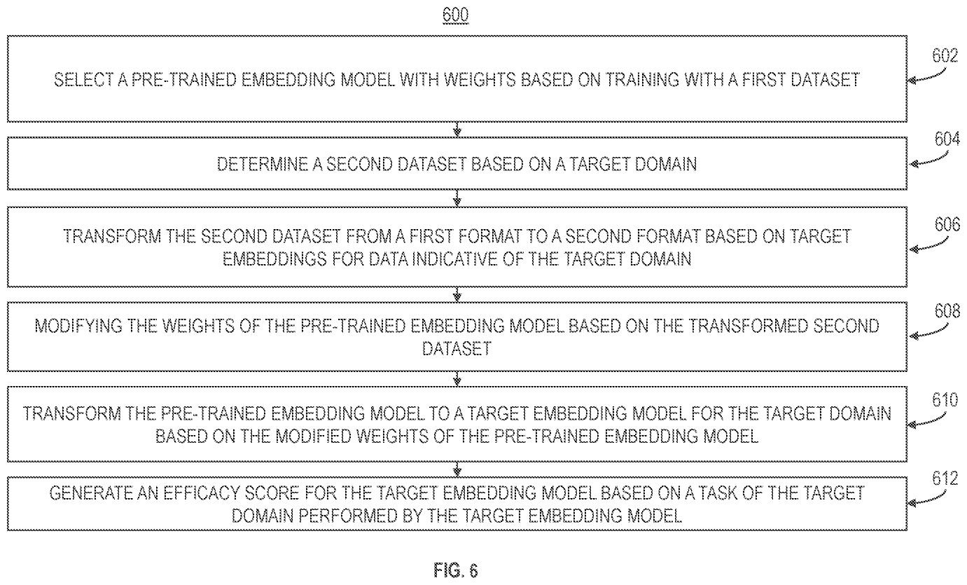

FIG. 6 shows a flowchart of an example method 600 for model customization for domain-specific tasks, according to some aspects of this disclosure. Method 600 can be performed by processing logic that can comprise hardware (e.g., circuitry, dedicated logic, programmable logic, microcode, etc.), software (e.g., instructions executing on a processing device), or a combination thereof. It is to be appreciated that not all steps may be needed to perform the disclosure provided herein. Further, some of the steps may be performed simultaneously, or in a different order than shown in FIG. 6, as will be understood by a person of ordinary skill in the art.

Method 600 shall be described with reference to FIGS. 1-3. However, method 600 is not limited to the aspects of those figures. A computer-based system (e.g., the multimedia environment 102, the system server(s) 126, etc.) may facilitate model customization for domain-specific tasks.

In 602, system server(s) 126 selects a pre-trained embedding model. According to some aspects of this disclosure, the pre-trained embedding model may be a generic language model including, but not limited to, word2vec, GloVe, BERT, and/or the like. According to some aspects of this disclosure, the pre-trained embedding model may include weights (e.g., weighted features used for forecasting and prediction task, etc.) based on training with a first dataset. According to some aspects of this disclosure, the first data set may include a large-scale, generic text dataset.

In 604, system server(s) 126 determines a second dataset. For example, system server(s) 126 may determine the second dataset based on a target domain. The target domain may include, but is not limited to, a content management system, a content retrieval system, a content delivery system, and/or the like. According to some aspects of this disclosure, the second dataset may be a domain-specific and/or behavior-based dataset. For example, the second data set may indicate data including content items that have been requested a threshold amount of times during a timeframe (e.g., popular content items, frequently requested content items, etc.), content item that have characters in their title that have been requested a threshold amount of times, and/or the like. According to some aspects of this disclosure, the second dataset may include textual data representative of the target domain.

In 606, system server(s) 126 transforms the second dataset from a first format to a second format. For example, system server(s) 126 may transform the second dataset from the first format to the second format based on target embeddings for the target domain. For example, target embeddings may be derived from characteristics, terminology, relationships, and/or the like for the target domain. According to some aspects of this disclosure, the second format may be associated with the target domain.

According to some aspects of this disclosure, system server(s) 126 transforming the second dataset from the first format to the second format may further include, but is not limited to, tokenization of data from the second dataset, stopword removal of data from the second dataset, stemming data from the second dataset, lemmatization of data from the second dataset, and/or the like.

In 608, system server(s) 126 modifies the weights of the pre-trained embedding model. For example, system server(s) 126 may modify the weights of the pre-trained embedding model based on the transformed second dataset. According to some aspects of this disclosure, system server(s) 126 may modify the weights of the pre-trained embedding model by generating a modified version of the transformed second dataset. For example, generating the modified version of the transformed second dataset may include, but is not limited to, skip-gram applied to the transformed second dataset, continuous bag of words (CBOW) applied to the transformed second dataset, and/or the like. According to some aspects of this disclosure, system server(s) 126 may output the modified weights of the pre-trained embedding model based on the pre-trained embedding model being trained with the modified version of the transformed second dataset.

In 610, system server(s) 126 transforms the pre-trained embedding model to a target embedding model for the target domain. For example, system server(s) 126 may transform the pre-trained embedding model to the target embedding model for the target domain based on the modified weights of the pre-trained embedding model.

In 612, system server(s) 126 generates an efficacy score for the target embedding model. For example, system server(s) 126 may generate the efficacy score for the target embedding model based on a task of the target domain performed by the target embedding model. The efficacy score may indicate how well and/or accurately the target embedding model performed the task of the target domain. According to some aspects of this disclosure, the task of the target domain may include, but is not limited to, a content item retrieval task for the target domain, a text classification task for the target domain, an entity recognition task for the target domain, a sentiment analysis task for the target domain, and/or the like.

According to some aspects of this disclosure, the method 600 may further include system server(s) 126 implementing the target embedding model within the target domain (e.g., multimedia environment 102, etc.). For example, system server(s) 126 may implement the target embedding model within the target domain based on the efficacy score for the target embedding model satisfying an efficacy score threshold for the target domain.

According to some aspects of this disclosure, each weight of the modified weights is associated with a respective content item of a plurality of content items for the target domain. According to some aspects of this disclosure, the method 600 may further include system server(s) 126 adjusting a weight of the modified weights based on an event in the target domain associated with the respective content item. For example, the event in the target domain may include, but is not limited to, a promotional/marketing event for the respective content item, a social media-influenced event for the respective content item, and/or the like.

### Example Computer System

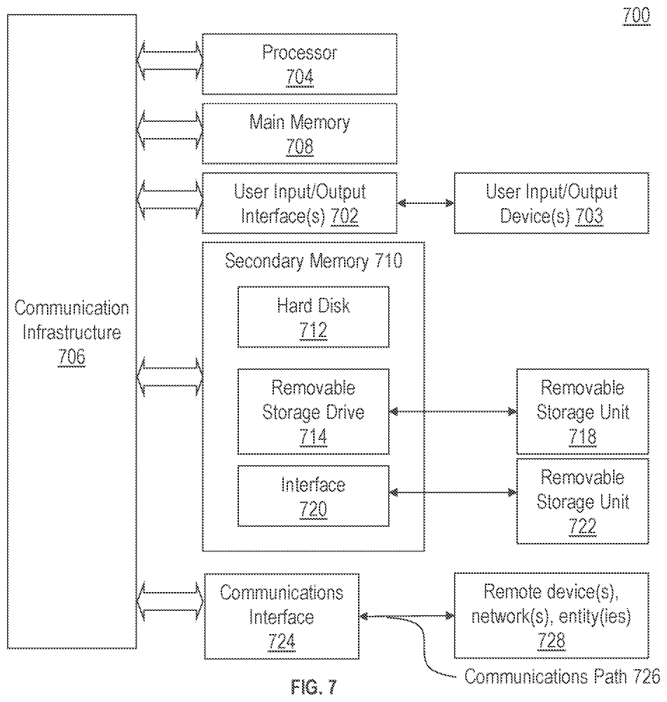

Various embodiments may be implemented, for example, using one or more well-known computer systems, such as computer system 700 shown in FIG. 7. For example, the media device 106 may be implemented using combinations or sub-combinations of computer system 700. Also or alternatively, one or more computer systems 700 may be used, for example, to implement any of the embodiments discussed herein, as well as combinations and sub-combinations thereof.

Computer system 700 may include one or more processors (also called central processing units, or CPUs), such as a processor 704. Processor 704 may be connected to a communication infrastructure or bus 706.

Computer system 700 may also include user input/output device(s) 703, such as monitors, keyboards, pointing devices, etc., which may communicate with communication infrastructure 706 through user input/output interface(s) 702.

One or more of processors 704 may be a graphics processing unit (GPU). In an embodiment, a GPU may be a processor that is a specialized electronic circuit designed to process mathematically intensive applications. The GPU may have a parallel structure that is efficient for parallel processing of large blocks of data, such as mathematically intensive data common to computer graphics applications, images, videos, etc.

Computer system 700 may also include a main or primary memory 708, such as random access memory (RAM). Main memory 708 may include one or more levels of cache. Main memory 708 may have stored therein control logic (i.e., computer software) and/or data.

Computer system 700 may also include one or more secondary storage devices or memory 710. Secondary memory 710 may include, for example, a hard disk drive 712 and/or a removable storage device or drive 714. Removable storage drive 714 may be a floppy disk drive, a magnetic tape drive, a compact disk drive, an optical storage device, a tape backup device, and/or any other storage device/drive.

Removable storage drive 714 may interact with a removable storage unit 718. Removable storage unit 718 may include a computer-usable or readable storage device having stored thereon computer software (control logic) and/or data. Removable storage unit 718 may be a floppy disk, magnetic tape, compact disk, DVD, optical storage disk, and/any other computer data storage device. Removable storage drive 714 may read from and/or write to removable storage unit 718.

Secondary memory 710 may include other means, devices, components, instrumentalities, or other approaches for allowing computer programs and/or other instructions and/or data to be accessed by computer system 700. Such means, devices, components, instrumentalities, or other approaches may include, for example, a removable storage unit 722 and an interface 720. Examples of the removable storage unit 722 and the interface 720 may include a program cartridge and cartridge interface (such as that found in video game devices), a removable memory chip (such as an EPROM or PROM) and associated socket, a memory stick and USB or other port, a memory card and associated memory card slot, and/or any other removable storage unit and associated interface.

Computer system 700 may further include a communication or network interface 724. Communication interface 724 may enable computer system 700 to communicate and interact with any combination of external devices, external networks, external entities, etc. (individually and collectively referenced by reference number 728). For example, communication interface 724 may allow computer system 700 to communicate with external or remote devices 728 over communications path 726, which may be wired and/or wireless (or a combination thereof), and which may include any combination of LANs, WANs, the Internet, etc. Control logic and/or data may be transmitted to and from computer system 700 via communication path 726.

Computer system 700 may also be any of a personal digital assistant (PDA), desktop workstation, laptop or notebook computer, netbook, tablet, smart phone, smart watch or other wearable, appliance, part of the Internet-of-Things, and/or embedded system, to name a few non-limiting examples, or any combination thereof.

Computer system 700 may be a client or server, accessing or hosting any applications and/or data through any delivery paradigm, including but not limited to remote or distributed cloud computing solutions; local or on-premises software (“on-premise” cloud-based solutions); “as a service” models (e.g., content as a service (CaaS), digital content as a service (DCaaS), software as a service (SaaS), managed software as a service (MSaaS), platform as a service (PaaS), desktop as a service (DaaS), framework as a service (FaaS), backend as a service (BaaS), mobile backend as a service (MBaaS), infrastructure as a service (IaaS), etc.); and/or a hybrid model including any combination of the foregoing examples or other services or delivery paradigms.

Any applicable data structures, file formats, and schemas in computer system 700 may be derived from standards including but not limited to JavaScript Object Notation (JSON), Extensible Markup Language (XML), Yet Another Markup Language (YAML), Extensible Hypertext Markup Language (XHTML), Wireless Markup Language (WML), MessagePack, XML User Interface Language (XUL), or any other functionally similar representations alone or in combination. Alternatively, proprietary data structures, formats or schemas may be used, either exclusively or in combination with known or open standards.

In some embodiments, a tangible, non-transitory apparatus or article of manufacture comprising a tangible, non-transitory computer useable or readable medium having control logic (software) stored thereon may also be referred to herein as a computer program product or program storage device. This includes, but is not limited to, computer system 700, main memory 708, secondary memory 710, and removable storage units 718 and 722, as well as tangible articles of manufacture embodying any combination of the foregoing. Such control logic, when executed by one or more data processing devices (such as computer system 700 or processor(s) 704), may cause such data processing devices to operate as described herein.

Based on the teachings contained in this disclosure, it will be apparent to persons skilled in the relevant art(s) how to make and use embodiments of this disclosure using data processing devices, computer systems and/or computer architectures other than that shown in FIG. 7. In particular, embodiments can operate with software, hardware, and/or operating system implementations other than those described herein.

### CONCLUSION

It is to be appreciated that the Detailed Description section, and not any other section, is intended to be used to interpret the claims. Other sections can set forth one or more but not all exemplary embodiments as contemplated by the inventor(s), and thus, are not intended to limit this disclosure or the appended claims in any way.

While this disclosure describes exemplary embodiments for exemplary fields and applications, it should be understood that the disclosure is not limited thereto. Other embodiments and modifications thereto are possible, and are within the scope and spirit of this disclosure. For example, and without limiting the generality of this paragraph, embodiments are not limited to the software, hardware, firmware, and/or entities illustrated in the figures and/or described herein. Further, embodiments (whether or not explicitly described herein) have significant utility to fields and applications beyond the examples described herein.

Embodiments have been described herein with the aid of functional building blocks illustrating the implementation of specified functions and relationships thereof. The boundaries of these functional building blocks have been arbitrarily defined herein for the convenience of the description. Alternate boundaries can be defined as long as the specified functions and relationships (or equivalents thereof) are appropriately performed. Also, alternative embodiments can perform functional blocks, steps, operations, methods, etc. using orderings different than those described herein.

References herein to “one embodiment,” “an embodiment,” “an example embodiment,” or similar phrases, indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it would be within the knowledge of persons skilled in the relevant art(s) to incorporate such feature, structure, or characteristic into other embodiments whether or not explicitly mentioned or described herein. Additionally, some embodiments can be described using the expression “coupled” and “connected” along with their derivatives. These terms are not necessarily intended as synonyms for each other. For example, some embodiments can be described using the terms “connected” and/or “coupled” to indicate that two or more elements are in direct physical or electrical contact with each other. The term “coupled,” however, can also mean that two or more elements are not in direct contact with each other, but yet still cooperate or interact with each other.

The breadth and scope of this disclosure should not be limited by any of the above-described exemplary embodiments, but should be defined only in accordance with the following claims and their equivalents.

What is claimed is:

1. A computer-implemented method for model customization for domain-specific tasks, comprising:
selecting, by at least one computer processor, a pre-trained embedding model, wherein the pre-trained embedding model comprises weights based on training the pre-trained embedding model with a first dataset;
determining, based on a target domain, a second dataset, wherein the second dataset comprises textual data representative of the target domain;
transforming, based on target embeddings for data indicative of the target domain, the second dataset from a first format to a second format, wherein the second format is associated with the target domain;
modifying, based on the transformed second dataset, the weights of the pre-trained embedding model;
transforming, based on the modified weights of the pre-trained embedding model, the pre-trained embedding model to a target embedding model for the target domain; and
generating, based on a task of the target domain performed by the target embedding model, an efficacy score for the target embedding model.

2. The computer-implemented method of claim 1, wherein the transforming the second dataset from the first format to the second format is further based on at least one of: tokenization of data from the second dataset, stopword removal of data from the second dataset, stemming data from the second dataset, or lemmatization of data from the second dataset.

3. The computer-implemented method of claim 1, wherein the modifying the weights of the pre-trained embedding model further comprises:
generating, based on at least one of skip-gram applied to the transformed second dataset or continuous bag of words (CBOW) applied to the transformed second dataset, a modified version of the transformed second dataset; and
outputting, based on the pre-trained embedding model trained with the modified version of the transformed second dataset, the modified weights of the pre-trained embedding model.

4. The computer-implemented method of claim 1, wherein the task of the target domain comprises at least one of: a content item retrieval task for the target domain, a text classification task for the target domain, an entity recognition task for the target domain, or a sentiment analysis task for the target domain.

5. The computer-implemented method of claim 1, further comprising implementing, based on the efficacy score for the target embedding model satisfying an efficacy score threshold for the target domain, the target embedding model within the target domain.

6. The computer-implemented method of claim 1, wherein the second dataset indicates at least one of a content item that has been requested a threshold amount of times during a timeframe, or a content item that has at least one character in a title that has been requested another threshold amount of times.

7. The computer-implemented method of claim 1, wherein each weight of the modified weights is associated with a respective content item of a plurality of content items for the target domain, the method further comprising adjusting a weight of the modified weights based on an event in the target domain associated with the respective content item.

8. A system, comprising:
one or more memories;
at least one processor each coupled to at least one of the memories and configured to perform operations for model customization for domain-specific tasks, the operations comprising:
selecting a pre-trained embedding model, wherein the pre-trained embedding model comprises weights based on training the pre-trained embedding model with a first dataset;
determining, based on a target domain, a second dataset, wherein the second dataset comprises textual data representative of the target domain;
transforming, based on target embeddings for data indicative of the target domain, the second dataset from a first format to a second format, wherein the second format is associated with the target domain;
modifying, based on the transformed second dataset, the weights of the pre-trained embedding model;
transforming, based on the modified weights of the pre-trained embedding model, the pre-trained embedding model to a target embedding model for the target domain; and
generating, based on a task of the target domain performed by the target embedding model, an efficacy score for the target embedding model.

9. The system of claim 8, wherein the transforming the second dataset from the first format to the second format is further based on at least one of: tokenization of data from the second dataset, stopword removal of data from the second dataset, stemming data from the second dataset, or lemmatization of data from the second dataset.

10. The system of claim 8, wherein the modifying the weights of the pre-trained embedding model further comprises:
generating, based on at least one of skip-gram applied to the transformed second dataset or continuous bag of words (CBOW) applied to the transformed second dataset, a modified version of the transformed second dataset; and
outputting, based on the pre-trained embedding model trained with the modified version of the transformed second dataset, the modified weights of the pre-trained embedding model.

11. The system of claim 8, wherein the task of the target domain comprises at least one of: a content item retrieval task for the target domain, a text classification task for the target domain, an entity recognition task for the target domain, or a sentiment analysis task for the target domain.

12. The system of claim 8, the operations further comprising implementing, based on the efficacy score for the target embedding model satisfying an efficacy score threshold for the target domain, the target embedding model within the target domain.

13. The system of claim 8, wherein the second dataset indicates at least one of a content item that has been requested a threshold amount of times during a timeframe, or a content item that has at least one character in a title that has been requested another threshold amount of times.

14. The system of claim 8, wherein each weight of the modified weights is associated with a respective content item of a plurality of content items for the target domain, the operations further comprising adjusting a weight of the modified weights based on an event in the target domain associated with the respective content item.

15. A non-transitory computer-readable medium having instructions stored thereon that, when executed by at least one computing device, cause the at least one computing device to perform operations for model customization for domain-specific tasks, the operations comprising:
selecting a pre-trained embedding model, wherein the pre-trained embedding model comprises weights based on training the pre-trained embedding model with a first dataset;
determining, based on a target domain, a second dataset, wherein the second dataset comprises textual data representative of the target domain;
transforming, based on target embeddings for data indicative of the target domain, the second dataset from a first format to a second format, wherein the second format is associated with the target domain;
modifying, based on the transformed second dataset, the weights of the pre-trained embedding model;
transforming, based on the modified weights of the pre-trained embedding model, the pre-trained embedding model to a target embedding model for the target domain; and
generating, based on a task of the target domain performed by the target embedding model, an efficacy score for the target embedding model.

16. The non-transitory computer-readable medium of claim 15, wherein the transforming the second dataset from the first format to the second format is further based on at least one of: tokenization of data from the second dataset, stopword removal of data from the second dataset, stemming data from the second dataset, or lemmatization of data from the second dataset.

17. The non-transitory computer-readable medium of claim 15, wherein the modifying the weights of the pre-trained embedding model further comprises:
generating, based on at least one of skip-gram applied to the transformed second dataset or continuous bag of words (CBOW) applied to the transformed second dataset, a modified version of the transformed second dataset; and
outputting, based on the pre-trained embedding model trained with the modified version of the transformed second dataset, the modified weights of the pre-trained embedding model.

18. The non-transitory computer-readable medium of claim 15, wherein the task of the target domain comprises at least one of: a content item retrieval task for the target domain, a text classification task for the target domain, an entity recognition task for the target domain, or a sentiment analysis task for the target domain.

19. The non-transitory computer-readable medium of claim 15, the operations further comprising implementing, based on the efficacy score for the target embedding model satisfying an efficacy score threshold for the target domain, the target embedding model within the target domain.

20. The non-transitory computer-readable medium of claim 15, wherein the second dataset indicates at least one of a content item that has been requested a threshold amount of times during a timeframe, or a content item that has at least one character in a title that has been requested another threshold amount of times.
